(19) United States
(12) Patent Application Publication
(10) Pub. No.: US 2007/0057476 A1
(43) Pub. Date: Mar. 15, 2007

(54) Hand cart

(76) Inventor: John R. Decky, Vero Beach, FL (US)

Correspondence Address: WELSH & FLAXMAN LLC, 2000 DUKE STREET, SUITE 100, ALEXANDRIA, VA, 22314, US

(21) Appl. No.: 11/500,548

(22) Filed: Aug. 8, 2006

Related U.S. Application Data
(63) Continuation-in-part of application No. 10/804,155, filed on Mar. 19, 2004, now abandoned.
(60) Provisional application No. 60/534,681, filed on Jan. 8, 2004.

(51) Int. Cl. B62B 1/00; B60P 1/04

(52) U.S. Cl. 280/47.28; 414/490

(57) ABSTRACT

A cart for moving large irregularly shaped articles includes a base including a forward end and a rearward end. The cart further includes first and second upwardly extending arms connected to the base. Each of the first and second upwardly extending arms includes a distal end coupled to the base and a proximal end having a handle shaped and dimensioned for gripping by an individual. A lift mechanism is positioned between the first and second upwardly extending arms. The lift mechanism includes a first support bar mounted adjacent the distal end of the first and second upwardly extending arms for selective movement along the first and second upwardly extending arms. The lift mechanism also includes a second support bar positioned above the first support bar and fixedly secured between the first and second upwardly extending arms. A crank arm extends between the second support bar and the first support bar, the crank arm permitting controlled movement of the first support bar along the length of the first and second upwardly extending arms.

### CROSS REFERENCE TO RELATED APPLICATIONS

This application is a continuation-in-part of U.S. patent application Ser. No. 10/804,155, entitled “Hand Cart”, filed Mar. 19, 2004, which is currently pending, which is based upon U.S. Provisional Application Ser. No. 60/534,681, entitled “Hand Cart”, filed Jan. 8, 2004.

### BACKGROUND OF THE INVENTION

1. Field of the Invention

The invention relates to a hand cart. More particularly, the invention relates to a hand cart for lifting, transporting and installing toilets.

2. Description of the Prior Art

Prior to the development of the present hand cart, transportation and installation of toilets has been an awkward and cumbersome operation, normally requiring at least two men to carry and precisely fit the toilet at an installation site. Because toilets are generally heavy and rather cumbersome to carry, workers are often injured and there is an extensive amount of breakage of the toilet itself because of mishandling.

Hand cart devices for both lifting and transporting heavy articles are known in the prior art. For example, U.S. Pat. No. 3,262,590 to Lynn, U.S. Pat. No. 3,391,905 to Burns, U.S. Pat. No. 4,722,511 to Chitwood, U.S. Pat. No. 5,203,065 to Peters, U.S. Pat. No. 5,373,593 to Decky et al., U.S. Pat. No. 5,716,183 to Gibson et al. and U.S. Pat. No. 6,135,466 to Irwin disclose a variety of devices for lifting, transporting and installing toilets. In addition, U.S. Pat. No. 1,820,263 to Williams shows a truck for transporting annular objects, such as wheels, including a wheeled cart and a hand operated screw jack for lifting the wheels onto the cart frame. U.S. Pat. No. 2,903,147 to Davis, Jr. shows a lifting and transporting cart for outboard motors, including a hand truck structure having a jack member which lifts and positions an outboard motor, enabling it to be attached to the back of a boat. U.S. Pat. No. 4,632,627 to Swallows shows a motor transport and worktable cart, including a base having front and rear wheels and an upright column, supported by the base, which in turn supports a platform for up and down movement by means of a winch.

As such, those skilled in the art will appreciate that a need exists for an improved hand cart, in particular, a hand cart adapted for transporting and installing toilets. The present invention provides a hand cart overcoming the shortcomings of prior art carts by providing a hand cart which is convenient, versatile and reliable.

### SUMMARY OF THE INVENTION

It is, therefore, an object of the present invention to provide a cart for moving large irregularly shaped articles. The cart includes a base having a forward end and a rearward end. The cart also includes first and second upwardly extending arms connected to the base, each of the first and second upwardly extending arms including a distal end coupled to the base and a proximal end. The cart also includes a lift mechanism positioned between the first and second upwardly extending arms. The lift mechanism includes a first support bar mounted adjacent the distal end of the first and second upwardly extending arms for selective movement along the first and second upwardly extending arms. The lift mechanism also includes a second support bar positioned above the first support bar and fixedly secured between the first and second upwardly extending arms. In addition, a crank arm extends between the second support bar and the first support bar, the crank arm permitting controlled movement of the first support bar along the length of the first and second upwardly extending arms.

It is also an object of the present invention to provide a cart wherein the base is substantially C-shaped.

It is another object of the present invention to provide a cart wherein the base includes an opening along the forward end.

It is a further object of the present invention to provide a cart wherein the base further includes a pair of rear wheels along the rearward end and a pair of front wheels along the forward end.

It is also another object of the present invention to provide a cart wherein the rear wheels are mounted to the base for rotation about a fixed axis and the front wheel being mounted to the base for pivotal movement permitting maneuvering of the cart.

It is yet another object of the present invention to provide a cart including handles having a rearwardly curved U-shaped member.

It is also a further object of the present invention to provide a cart wherein a forward end of the U-shaped member is aligned with the distal end of the upwardly extending arms and a rearward end of the of the U-shaped member is aligned with a rear edge of the pair of rear wheels permitting inversion of the cart with the pair of rear wheel and rearward end of the U-shaped member support the cart.

It is also an object of the present invention to provide a cart wherein the first support bar includes first and second coupling members for selectively coupling the first support bar to the article.

It is another object of the present invention to provide a cart wherein the first and second coupling members are elongated bodies shaped end and dimensioned for ready engagement with the article.

It is a further object of the present invention to provide a cart wherein the first and second coupling members are secured to the first support bar for selective movement relative thereto in a manner permitting ready attachment to the article.

It is also an object of the present invention to provide a cart wherein the first support bar includes slots in which the first and second coupling members are mounted for movement along the first support bar.

It is yet a further object of the present invention to provide a cart wherein the first and second coupling member each include locators assisting in attachment to an article.

It is another object of the present invention to provide a cart wherein the crank arm includes a threaded shaft that engages a threaded cylinder secured to the first support bar.

It is also an object of the present invention to provide a cart wherein the threaded shaft is telescopically received within the threaded cylinder.

It is also another object of the present invention to provide a cart wherein the crank arm includes a handle.

It is still a further object of the present invention to provide a cart wherein the base is collapsible.

It is also an object of the present invention to provide a cart wherein the base includes first and second lateral frame members.

It is another object of the present invention to provide a cart wherein the first and second lateral frame members are selectively collapsible.

It is a further object of the present invention to provide a cart wherein the base further includes a pair of rear wheels along a rearward end and a pair of front wheels along a forward end.

It is yet another object of the present invention to provide a cart wherein the rear wheels are mounted to the base for rotation about a fixed axis and the front wheel being mounted to the base for pivotal movement permitting maneuvering of the cart.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the present cart.

FIG. 2 is a perspective view of the present cart with a toilet secured thereto.

FIGS. 3 to 7 show the steps associated in securing a toilet to the present cart.

FIGS. 8 to 11 show the steps associated with lifting a toilet into a vehicle in accordance with the present invention.

FIG. 12 is a perspective view of an alternate embodiment of the present invention.

FIG. 13 is a detailed perspective view of the alternate embodiment shown in FIG. 12 showing the front wheel in a use position.

FIG. 14 is a detailed perspective view of the alternate embodiment shown in FIG. 12 showing the front wheel in a storage position.

FIG. 15 shows a perspective view in accordance with another alternate embodiment of the present invention with the leveling assembly shown detached from the first support bar.

FIG. 16 is a detailed exploded view of a leveling assembly employed in accordance with the embodiment shown with reference to FIG. 15.

FIG. 17 is a front view of the embodiment shown with reference to FIG. 15.

FIGS. 18, 19, 20, 21, 22 show the steps associated with lifting a toilet with the embodiment shown with reference to FIG. 15.

FIG. 23 shows the embodiment of FIG. 15 with the rear wheels inwardly positioned.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

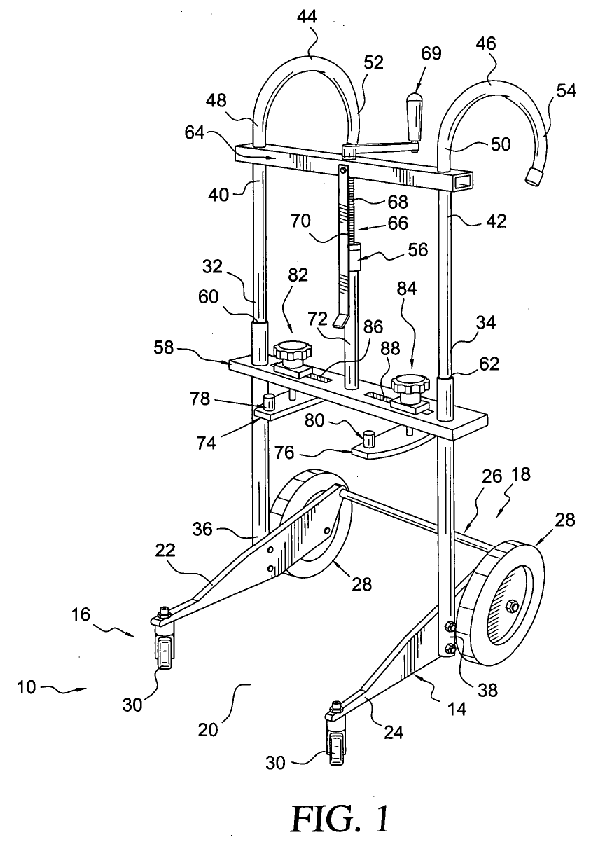

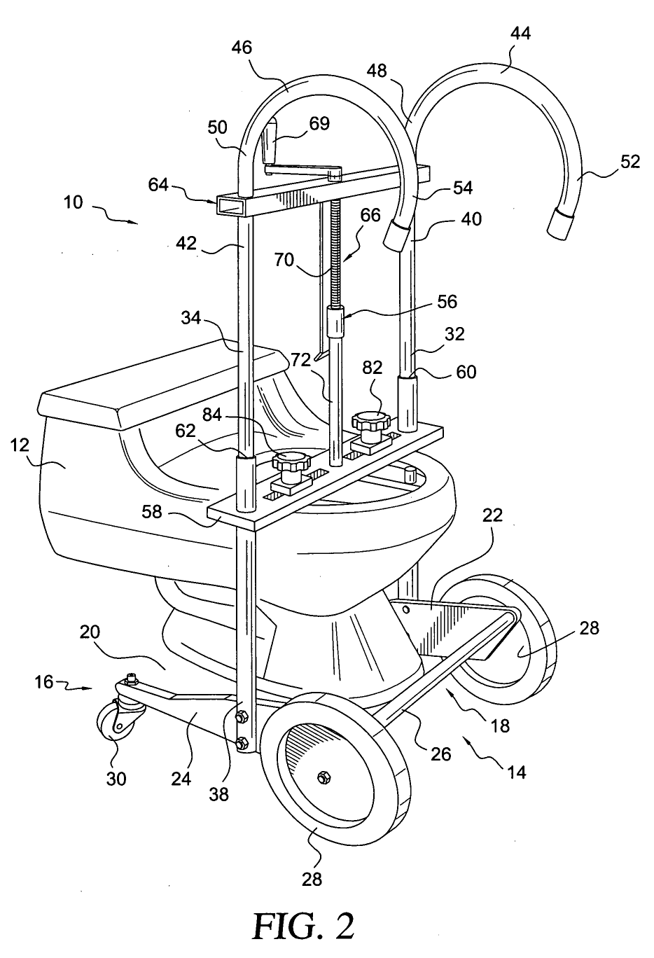

With reference to FIGS. 1 and 2, a cart 10 for moving large irregularly shaped articles is disclosed. In particular, the cart 10 is adapted for lifting, transporting and installing toilets 12. As such, and as will be described below in greater detail, the cart 10 includes a variety of features facilitating the convenient transport of toilets 12 into and out of various installation sites. In addition, the cart 10 is designed for space savings, support of installation tools and convenient storage. While the cart 10 is particularly adapted for use with toilets 12, it is contemplated the cart 10 may be used for a variety of purposes without departing from the spirit of the present invention.

The cart 10 includes a base 14 having a forward end 16 and a rearward end 18. The base 14 is substantially C-shaped and includes an opening 20 along the forward end 16. As will be described below in greater detail, the opening 20 permits the cart 10 to be positioned directly above a toilet 12. The base 14 is composed of first and second lateral frame members 22, 24 and a rear transverse frame member 26 connecting the lateral frame members 22, 24 to form the C-shaped base 14. The rear transverse member 26 connects the first and second lateral frame members 22, 24 adjacent the rearward end 18 of the base 14 to thereby create the opening 20 at the forward end 16 of the base 14.

The base 14 includes a pair of rear wheels 28 positioned along the rearward end 18 of the base 14. The rear wheels 28 are respectively secured to the first and second lateral frame members 22, 24 at the rearward end 18 of the base 14. The base 14 further includes a pair of front wheels 30 positioned at the forward end 16 of the base 14. The front wheels 30 are respectively mounted to the first and second lateral frame members 22, 24 at the forward end 16 of the base 14.

With regard to the rear wheels 28, they are mounted to the base 14 for rotation about a fixed axis. In contrast, the front wheels 30 are mounted to the base 14 for pivotal or swivel movement in a manner permitting maneuvering of the cart 10. In accordance with a preferred embodiment of the present invention, the front wheels 30 are caster mounted, permitting a wide range of motion while the rear wheels 28 are larger than the front wheels 30 enhancing the stability of the present cart 10.

The cart 10 further includes first and second upwardly extending arms 32, 34. The first and second upwardly extending arms 32, 34 are connected to the base 14 in a manner defining a first plane therebetween. Each of the first and second upwardly extending arms 32, 34 includes a distal end 36, 38, respectively, directly coupled to respective lateral fame members 22, 24 at a position slightly in front of the rear wheels 28. Each of the first and second upwardly extending arms 32, 34 also includes a proximal end 40, 42, respectively, shaped and dimensioned for gripping by a user.

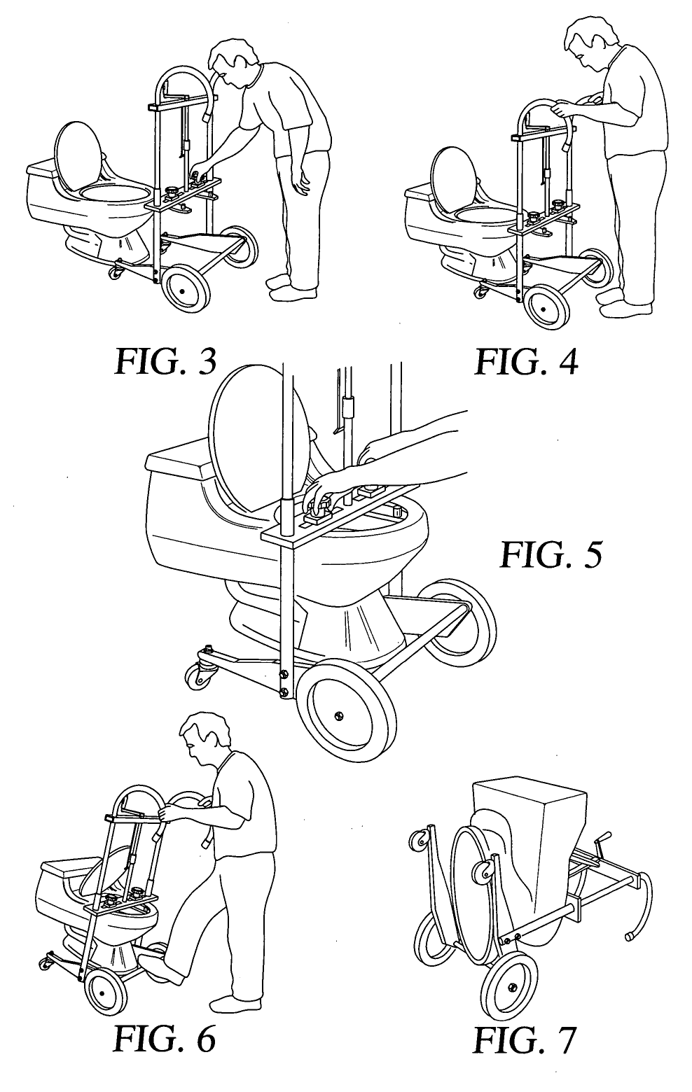

With this in mind, the proximal ends 40, 42 of the first and second upwardly extending arms 32, 34 each include a handle 44, 46 shaped and dimensioned for gripping by an individual. Each handle 44, 46 is composed of a rearwardly curved and downwardly facing U-shaped member. The forward end 48, 50 of the U-shaped member is aligned with the distal end 36, 38 of the upwardly extending arms 32, 34 and the rearward end 52, 54 of the U-shaped member is aligned with the rear edge of the pair of rear wheels 28. By aligning the rearward end 52, 54 of the U-shaped member with the rear edge of the pair of rear wheels 28, inversion of the cart is permitted for improving ease of installation and transport (see FIGS. 3 to 12).

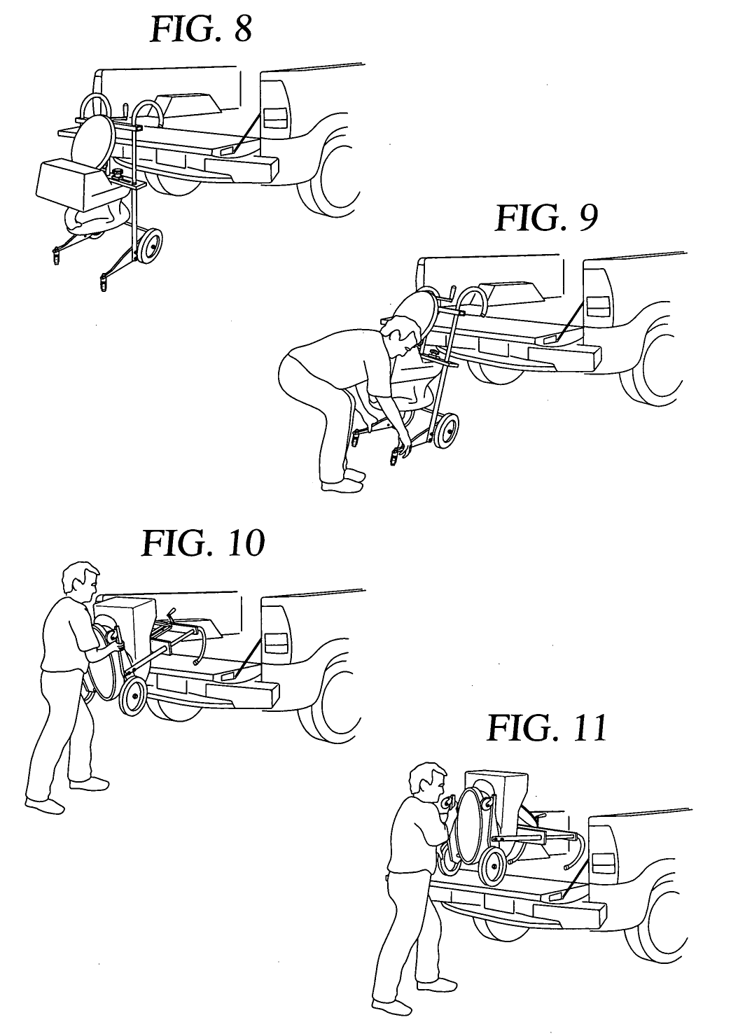

For example, inversion of the cart 10 is contemplated to be useful when a wax seal is being replaced (see FIGS. 3 to 7), when the cart 10 is placed within a vehicle (see FIGS. 8 to 12) and for other maneuvers one might encounter during the installation and/or transport of a toilet 12.

In addition to the first and second upwardly extending arms 32, 34, the present cart 10 is provided with a lift mechanism 56 positioned between the first and second upwardly extending arms 32, 34. The lift mechanism 56 facilitates attachment of the cart 10 to a toilet 12, lifting of the toilet 12 from an installation position or a storage position, support of the toilet as it is transported from one site to another, positioning of the toilet 12 at a desired installation site and lowering of the toilet 12 into position.

With this in mind, the lift mechanism 56 includes a first support bar 58 mounted proximate the distal end 36, 38 of the first and second upwardly extending arms 32, 34 for selective movement along the first and second upwardly extending arms 32, 34. The first support bar 58 includes respective first and second apertures 60, 62 through which the first and second upwardly extending arms 32, 34 extend such that the first support bar 58 may ride along the first and second upwardly extending arms 32, 34 as it is moved along the length of the first and second upwardly extending arms 32, 34.

The lift mechanism 56 also includes a second support bar 64 fixedly secured to the first and second upwardly extending arms 32, 34 at a position above the first support bar 58. The second support bar 64 supports a crank arm 66 that extends between the second support bar 64 and the first support bar 58. The crank arm 66 permits controlled movement of the first support bar 58 along the length of the first and second upwardly extending arms 32, 34.

In particular, the crank arm 66 includes a shaft 68 with a threaded external surface 70. The threaded external surface 70 engages a threaded cylinder 72 formed within the center of the first support bar 58 and extending upwardly therefrom. The threaded shaft 68 is telescopically received with the threaded cylinder 72 extending upwardly from the first support bar 58. As such, rotation of the crank arm 66 causes the threaded cylinder 72, and consequently the first support bar 58 to move up and down. Since the distal end of the crank arm 66 is connected to the first support bar 58, the first support bar 58 is moved up and down in a controlled manner as a user rotates the crank arm 66. Rotation of the crank arm 66 is facilitated by including a handle 69 at the proximal end of the crank arm 66.

Attachment of the first support bar 58 to a toilet 12 is achieved through the utilization of first and second coupling members 74, 76. The first and second coupling members 74, 76 are elongated bodies positioned within the first plane defined by the first and second upwardly extending arms 32, 34 and extending substantially perpendicular to the longitudinal axis of the first support bar 58 as well as the first plane defined by the first and second upwardly extending arms 32, 34. As such, the first and second coupling members 74, 76 are shaped and dimensioned for fitting within the inner rim of a toilet 12 in a manner permitting the toilet 12 to be lifted upwardly through the utilization of the crank arm 66 such that it is positioned within the first plane defined by the first and second upwardly extending arms 32, 34. Attachment to the toilet 12 is further enhanced by providing the first and second coupling members 74, 76 with locaters 78, 80 that may be used to ensure proper positioning of the first and second coupling members 74, 76 relative to the rim of the toilet bowl 12. The locaters 78, 80 may be of a color different from the rest of the device to provide for enhanced visible recognition. This makes it easier to locate them under the rim of the toilet bowl.

More particularly, the first and second coupling members 74, 76 are secured to the first support bar 58 by screw mechanisms 82, 84 or clamping knobs. The screw mechanism 82, 84 allows the first and second coupling 74, 76 members to be drawn toward the first support bar 58 to thereby pin the toilet bowl rim between the first support bar 58 and the first and second coupling members 74, 76.

Movement of the first and second coupling members 74, 76 to accommodate various toilets 12 is achieved by the provision of slots 86, 88 within the first support bar 58. The slots 86, 88 permit longitudinal and rotational movement of the first and second coupling members 74, 76 for proper positioning of the coupling members 74, 76 within and beneath the rim of a toilet 12.

The features of the present toilet cart 10 facilitate ease of transport. For example, the large rear wheels 28 help in moving the toilet 12 up a flight of stairs. The relationship between the handles 44, 46 and the rear wheels 28 allow for inversion of the toilet 12 and cart 10 providing for ease of transport. Further, the overall structure of the cart 10 provides users with a space saving device upon which an operator may easily stack tools and move from job to job.

The present cart 10 is especially adapted for transporting a toilet or even assisting in the replacement of a wax seal. Once the toilet 12 is fully secured it may be rotated to an inverted orientation for simple replacement of a seal or moved to another location. Regardless of the ultimate goal, the toilet 12 is secured to the present cart 10 in the following manner.

With reference to FIGS. 3 to 7, the cart 10 is first moved to a position above the toilet 12 and the first and second coupling members 74, 76 are moved toward the center of the first support arm 58 along the respective slots 86, 88 formed therein. Thereafter, the cart 10 is centered over the toilet bowl. As mentioned above, positioning of the cart 10 in this manner is facilitated by keeping the forward end 16 of the base 14 open. Thereafter, the first support bar 58 is lowered into contact with the upper surface of the toilet bowl rim. The first support bar 58 may include a pad thereon, which contacts the rim of the toilet 12 so as to prevent damage to the toilet bowl. For example, the first support bar 58 should be lowered, via the crank arm 66, until all four wheels 28, 30 of the base are positioned off of the ground by a distance of approximately one inch.

The first and second coupling members 74, 76 are then slid under the toilet bowl rim until the locators 78, 80 positioned at the ends of the first and second coupling members 74, 76 are in contact with the underside of the toilet bowl rim. The clamping knobs 82, 84 associated with the first and second coupling members 74, 76 are then rotated to draw the first and second coupling members 74, 76 toward the first support bar 58 until the toilet bowl rim is securely held between the first support bar 58 and the first and second coupling members 74, 76. Finally, the crank arm 66 is rotated to first move the wheels 28, 30 into contact with the support surface and subsequently move the first support bar 58 upward until the toilet 12 is at a desired height.

Thereafter, the individual may move the toilet 12 as desired. For example, the user may place his or her foot on the transverse frame member 26 to tilt the toilet 12 forward to a resting position where the toilet 12 is inverted and the handles 44, 46 and rear wheels 28 support the entire assembly in a stable four-point configuration with the first and second upwardly extending arms 32, 34 substantially parallel with the support surface. The use may then replace the wax seal while the toilet 12 sits securely supported. Similarly, the individual may use the cart 10 to transport the toilet 12 to another location. Regardless of the ultimate goal, the toilet 12 is installed in a desired location by simply reversing the removal steps described above.

As shown in FIGS. 8 to 11, the present cart 10 is also useful in loading a toilet 12 onto a work truck. This is accomplished by first securing the toilet 12 to the cart 10 as discussed above. Thereafter, the toilet 12 is cranked such that the first support bar 58 is lifted to its highest position. The user then places the rearward portion of the handles 44, 46 over the tailgate and lifts the forward end of the base 14 to slide the cart 10 and toilet 12 within the bed of the vehicle.

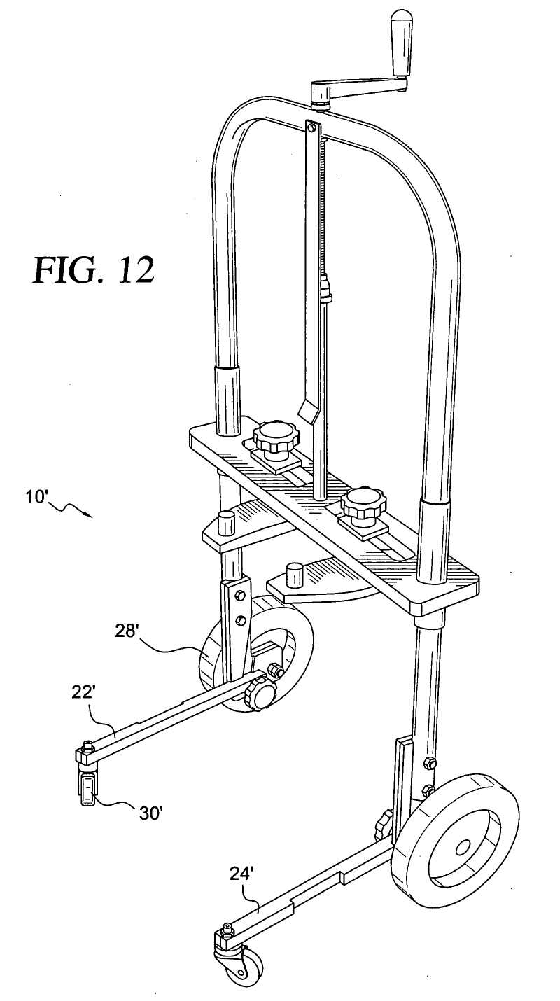

In accordance with an alternate embodiment of the present invention, and with reference to FIGS. 12, 13 and 14, the cart 10′ may be provided with collapsible first and second lateral frame members 22′, 24′. The first lateral frame member 22′ will now be described in detail, and those skilled in the art will appreciate that the second lateral frame member 24′ is substantially identical.

The first lateral frame member 22′ includes a forward arm 86′ on which the front wheel 30′ is mounted and a rear support plate 88′ on which the rear wheel 28′ is mounted. The rear support plate 88′ further includes an upwardly extending flange 90′ which is secured to the first upwardly extending arm 32′.

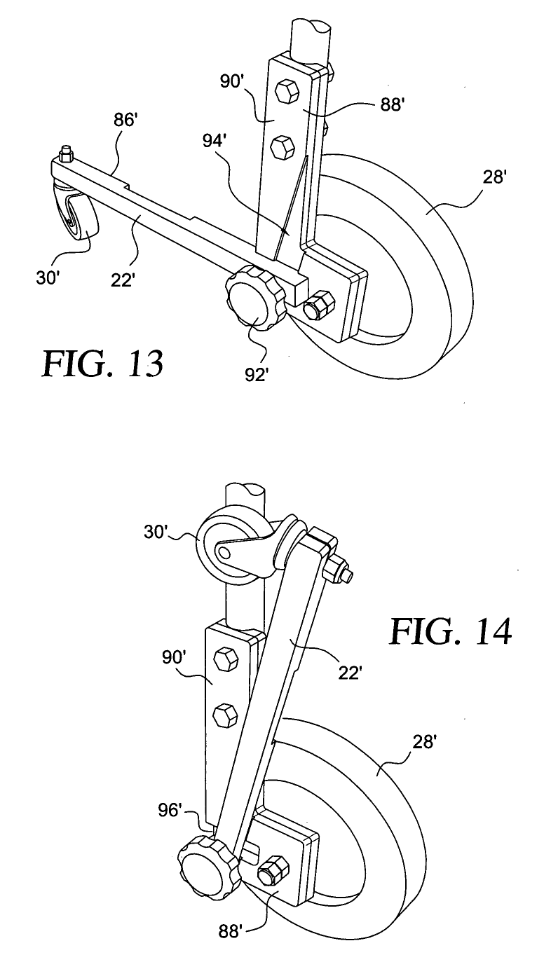

Briefly, the forward arm 86′ is pivotally secured to the rear support plate 88′ for selective movement between a forward use position (see FIGS. 12 and 13) and a rotated storage position (see FIG. 14). Controlled movement of the forward arm 86′ is achieved through the use of a set screw 92′, a storage groove 94′ (see FIG. 13) and a use groove 96′ (see FIG. 12). In particular, the set screw 92′ provides the pivot point for the forward arm 86′ and further permits the selective locking of the forward arm 86′ between the forward use position and the rotated storage position.

Controlled positioning of the forward arm 86′ is achieved by clamping the forward arm 86′ within either the storage groove 94′ or the use groove 96′. When a user wishes to switch from one orientation to another, the set screw 92′ is simply rotated to a released configuration, the forward arm 86′ is moved out of the respective groove 94′, 96′ and rotated to the other groove, and the set screw 92′ is then tightened to securely hold the forward arm 86′ within the chosen groove 94′, 96′.

In addition to the storage feature offered by the alternate embodiment, the alternate embodiment includes a one-piece frame structure. It is believed this may improve the ease of manufacture and use.

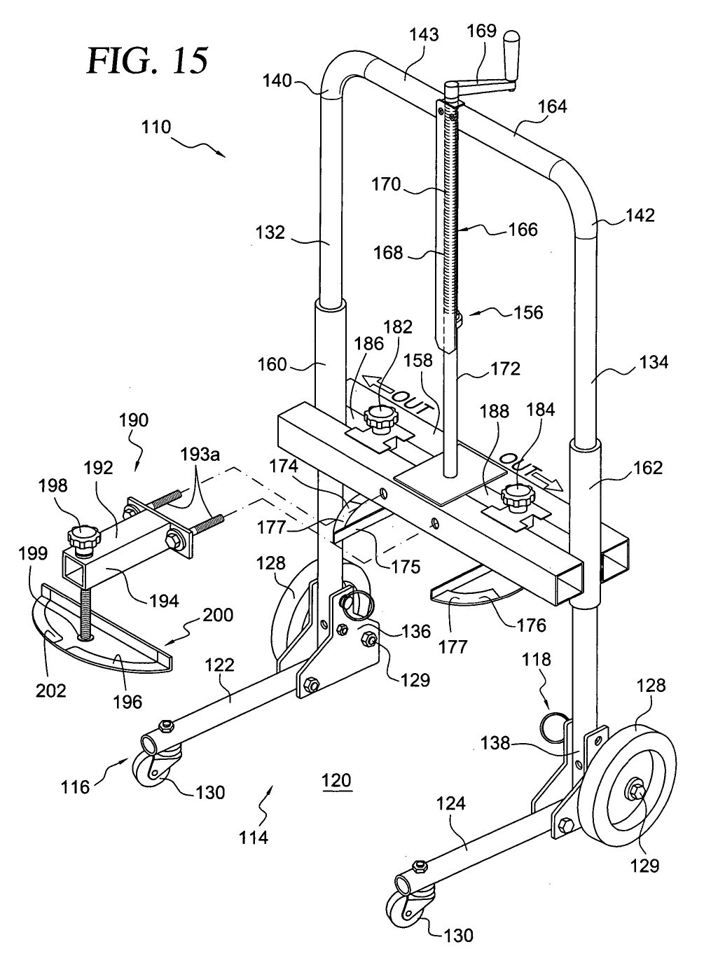

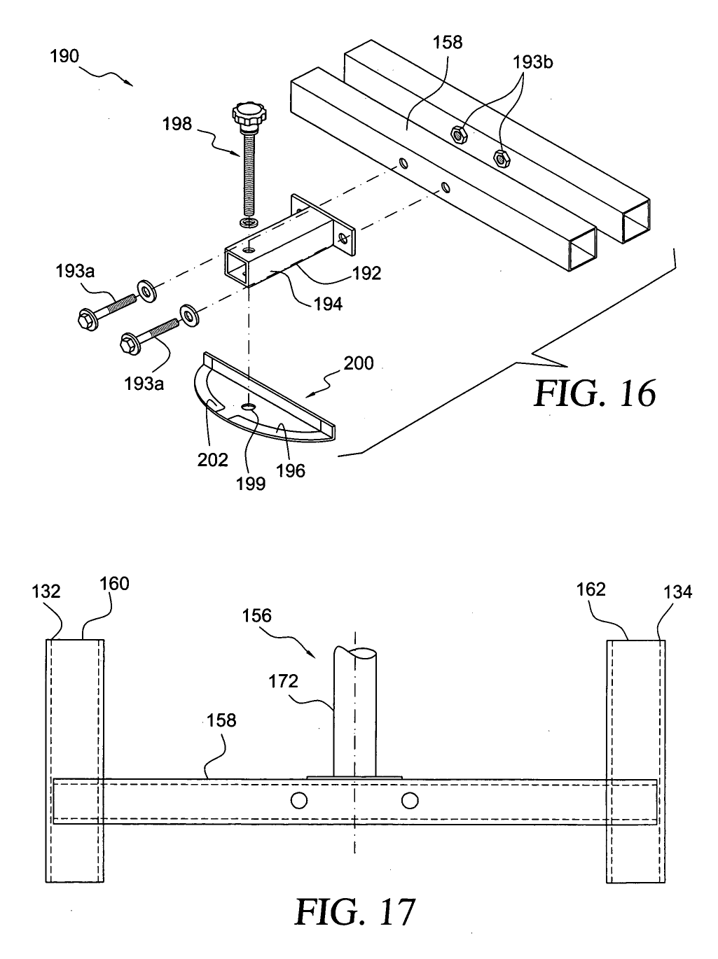

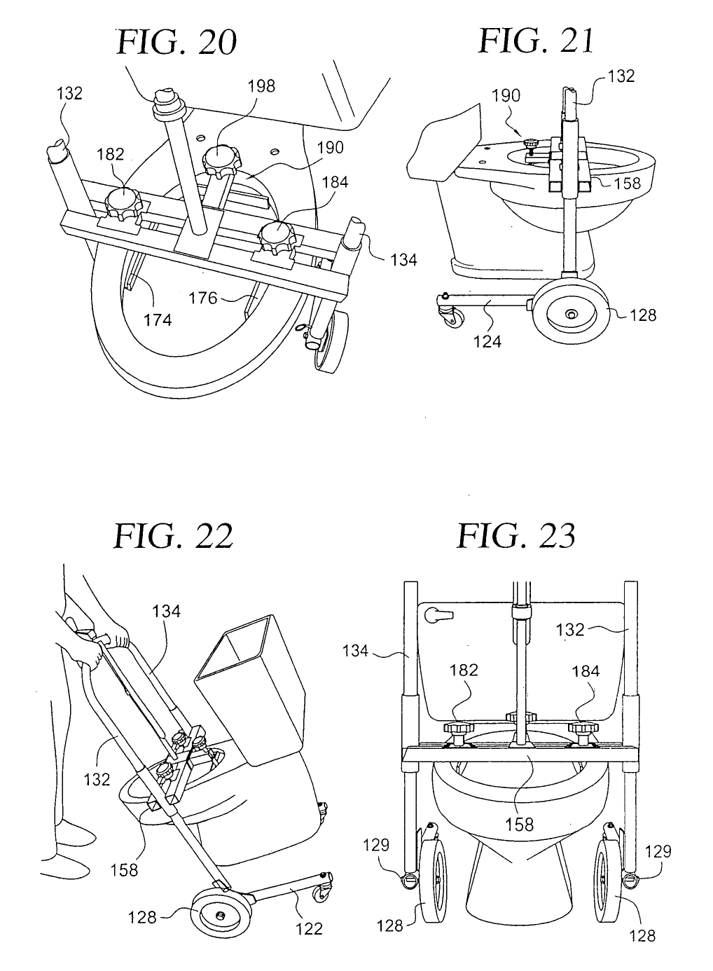

An additional embodiment is disclosed with reference to FIGS. 15 to 23. This embodiment adds a leveling assembly 190 in combination with lateral coupling members 174, 176 to securely support, lift and move a toilet. More specifically, the cart 110 includes a base 114 having a forward end 116 and a rearward end 118. The base 114 includes an opening 120 along the forward end 116. As with the prior embodiment, the opening 120 permits the cart 110 to be positioned directly above a toilet 112. The base 114 is composed of first and second lateral frame members 122, 124.

The base 114 includes a pair of rear wheels 128 positioned along the rearward end 118 of the base 114. The rear wheels 128 are respectively secured to the first and second lateral frame members 122, 124 at the rearward end 118 of the base 114. The base 114 further includes a pair of front wheels 130 positioned at the forward end 116 of the base 114. The front wheels 130 are respectively mounted to the first and second lateral frame members 122, 124 at the forward end 116 of the base 114.

With regard to the rear wheels 128, they are mounted to the base 114 for rotation about a fixed axis. In contrast, the front wheels 130 are mounted to the base 114 for pivotal or swivel movement in a manner permitting maneuvering of the cart 110.

The cart 110 further includes first and second upwardly extending arms 132, 134. The first and second upwardly extending arms 132, 134 are connected to the base 114 in a manner defining a first plane therebetween. Each of the first and second upwardly extending arms 132, 134 includes a distal end 136, 138, respectively, directly coupled to respective lateral fame members 122, 124 at a position slightly in front of the axle 129 of rear wheels 128. While the wheels 128 are shown secured to the outer surface of the first and second lateral frame members 122, 124, the brackets 131 securing the wheels 128 and the upwardly extending members 132, 134 may be removed allowing for mounting of the wheels 128 along the inner surface of the first and second lateral frame members 122, 124 (see FIG. 23) by simply switching the brackets 131 between the first and second lateral frame members 122, 124. Mounting of the wheels 128 along the inner surface allows for possible access to tight or narrow areas. Each of the first and second upwardly extending arms 132, 134 also includes a proximal end 140, 142, respectively, connected by a handle member 143 shaped and dimensioned for gripping by a user.

In addition to the first and second upwardly extending arms 132, 134, the present cart 110 is provided with a lift mechanism 156 positioned between the first and second upwardly extending arms 132, 134. The lift mechanism 156 facilitates attachment of the cart 110 to a toilet 12, lifting of the toilet 12 from an installation position or a storage position, support of the toilet 12 as it is transported from one site to another, positioning of the toilet 12 at a desired installation site and lowering of the toilet 12 into position.

The lift mechanism 156 includes a first support bar 158 mounted proximate the distal end 136, 138 of the first and second upwardly extending arms 132, 134 for selective movement along the first and second upwardly extending arms 132, 134. The first support bar 158 includes respective first and second apertures 160, 162 through which the first and second upwardly extending arms 132, 134 extend such that the first support bar 158 may ride along the first and second upwardly extending arms 132, 134 as it is moved along the length of the first and second upwardly extending arms 132, 134.

The lift mechanism 156 also includes a second support bar 164 (which in the case of this embodiment is part of the handle member 143 connecting the first and second upwardly extending arms 132, 134) fixedly secured to the first and second upwardly extending arms 132, 134 at a position above the first support bar 158. The second support bar 164 supports a crank arm 166 that extends between the second support bar 164 and the first support bar 158. The crank arm 166 permits controlled movement of the first support bar 158 along the length of the first and second upwardly extending arms 132, 134.

In particular, the crank arm 166 includes a shaft 168 with a threaded external surface 170. The threaded external surface 170 engages a threaded cylinder 172 formed within the center of the first support bar 158 and extending upwardly therefrom. The threaded shaft 168 is telescopically received with the threaded cylinder 172 extending upwardly from the first support bar 158. As such, rotation of the crank arm 166 causes the threaded cylinder 172, and consequently the first support bar 158 to move up and down. Since the distal end of the crank arm 166 is connected to the first support bar 158, the first support bar 158 is moved up and down in a controlled manner as a user rotates the crank arm 166. Rotation of the crank arm 166 is facilitated by including a handle 169 at the proximal end of the crank arm 166.

Attachment of the first support bar 158 to a toilet 112 is achieved through the utilization of first and second coupling members 174, 176. The first and second coupling members 174, 176 are elongated bodies positioned beneath the first support bar 158 and extending substantially perpendicular to the longitudinal axis of the first support bar 158.

The first and second coupling members 174, 176 are shaped and dimensioned for fitting within the inner rim of a toilet 12 in a manner permitting the toilet 12 to be lifted upwardly through the utilization of the crank arm 166. The first and second coupling members 174, 176 are generally L-shaped with a vertical leg 175 and a semi-elliptical horizontal leg 177. The L-shaped coupling members 174, 176 are oriented such that the concave portion of the L-shaped coupling members 174, 176 faces outwardly toward the respective first and second upwardly extending arms 132, 134. The semi-elliptical horizontal leg 177 is shaped and dimensioned to fit beneath the rim of the toilet bowl such that it may be secured between the first support bar 158 and the first and second coupling members 174, 176. As such, the first and second coupling members 174, 176 lie within, and extend substantially perpendicular to, the first plane defined by the first and second upwardly extending arms 132, 134 for supporting the article within the first plane.

The first and second coupling members 174, 176 are secured to the first support bar 158 by screw mechanisms 182, 184 or clamping knobs. The screw mechanism 182, 184 allows the first and second coupling 174, 176 members to be drawn toward the first support bar 158 to thereby pin the toilet bowl rim between the first support bar 158 and the first and second coupling members 174, 176.

Movement of the first and second coupling members 174, 176 to accommodate various toilets 12 is achieved by the provision of slots 186, 188 within the first support bar 158. The slots 186, 188 permit longitudinal and rotational movement of the first and second coupling members 174, 176 for proper positioning of the coupling members 174, 176 within and beneath the rim of a toilet 12.

The cart 110 is also provided with a leveling assembly 190 designed to work with the coupling members 174, 176 in ensuring secure and convenient removal and transport of a toilet 12. The leveling assembly 190 includes a support arm 192 secured to the first support bar 158 via bolts 193a and nuts 193b. The support arm 192 extends perpendicularly from the center of the first support bar 158 in the direction of the forward end 116 of the base 114. The support arm 158 includes a free end 194 to which a leveling clamp 196 is secured. The leveling clamp 196 is positioned beneath the support arm 192 and is positioned relative thereto for ready adjustment through the use of an adjustment mechanism 198. In accordance with a preferred embodiment, the adjustment mechanism 198 is a screw mechanism which engages a threaded hole 199 in the leveling clamp 196 to draw the leveling clamp 196 up and down relative to the support arm 192 by rotation thereof in a manner well know to those skilled in the art.

As with the coupling members 174, 176, the leveling clamp 196 is generally L-shaped with a vertical leg 200 and a semi-elliptical horizontal leg 202. The L-shaped leveling clamp 196 is oriented such that the concave portion thereof faces outwardly toward the forward end 116 of the base 114. The semi-elliptical horizontal leg 202 is shaped and dimensioned to fit beneath the rim of the toilet bowl.

As with the prior embodiment, the present cart 110 is especially adapted for transporting a toilet or even assisting in the replacement of a wax seal. Once the toilet 12 is fully secured, it may be rotated to an inverted orientation for simple replacement of a seal or moved to another location. Regardless of the ultimate goal, the toilet 12 is secured to the present cart 110 in the following manner.

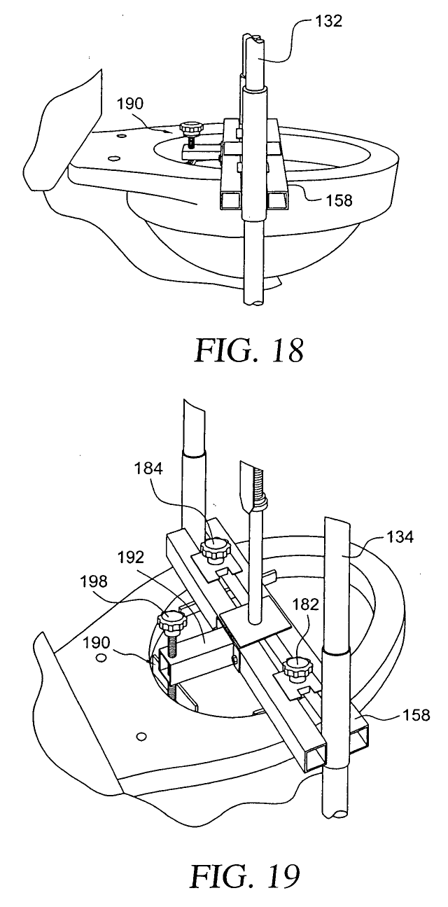

In practice, and with reference to FIGS. 18 to 22, the cart 110 is first moved to a position above the toilet 12 and the first and second coupling members 174, 176 are moved toward the center of the first support arm 158 along the respective slots 186, 188 formed therein. Thereafter, the cart 110 is centered over the toilet bowl. As mentioned above, positioning of the cart 110 in this manner is facilitated by keeping the forward end 116 of the base 114 open. Thereafter, the first support bar 158 is lowered into contact with the upper surface of the toilet bowl rim. The first support bar 158 may include a pad thereon, which contacts the rim of the toilet 12 so as to prevent damage to the toilet bowl. For example, the first support bar 158 should be lowered, via the crank arm 166, until all four wheels 128, 130 of the base 114 are positioned off of the ground by a distance of approximately one inch.

The leveling assembly 190 is then positioned on the rear rim of the toilet bowl and the cart 100 is moved forward until the it stops and the leveling clamp 196 of the leveling assembly 190 is fully under the rear rim of the toilet bowl. The first and second coupling members 174, 176 are then slid outwardly under the toilet bowl rim. The clamping knobs 182, 184 associated with the first and second coupling members 174, 176 are then rotated to draw the first and second coupling members 174, 176 toward the first support bar 158 until the toilet bowl rim is securely held between the first support bar 158 and the first and second coupling members 174, 176. The adjustment mechanism 198 of the leveling assembly 190 is then adjusted to ensure that the toilet 12 is level for moving.

Finally, the crank arm 166 is rotated to first move the wheels 128, 130 into contact with the support surface and subsequently move the first support bar 158 upward until the toilet 12 is at a desired height. Thereafter, the individual may move the toilet 12 as desired.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A cart for moving large irregularly shaped articles, comprising:
a base including a forward end and a rearward end, the base having first and second lateral frame members creating an opening at the forward end of the base, and the base also includes a pair of rear wheels respectively secured to the first and second lateral frame members at the rearward end of the base;
first and second upwardly extending arms respectively connected to the first and second lateral frame members, each of the first and second upwardly extending arms including a distal end coupled to the base and a proximal end, wherein the first and second upwardly extending arms define a first plane formed therebetween;
a lift mechanism positioned between the first and second upwardly extending arms, the lift mechanism including a first support bar mounted adjacent the distal end of the first and second upwardly extending arms for selective movement along the first and second upwardly extending arms, wherein the first support bar includes first and second coupling members for selectively coupling the first support bar to the article, wherein the first and second coupling members shaped and dimensioned for ready engagement with the article such that the article lies within the first plane, the first and second coupling members are positioned within, and extend substantially perpendicularly relative to, the first plane and the first support bar is positioned within the first plane, the lift mechanism also includes a second support bar positioned above the first support bar, the second support bar including a first end and a second end, the first and second ends of the second support bar being fixedly secured to the first and second upwardly extending arms respectively, a crank arm extends between the second support bar and the first support bar, the crank arm permitting controlled movement of the first support bar along the length of the first and second upwardly extending arms;
the first and second coupling members ate respectively secured to the first support bar by screw mechanisms allowing the first and second coupling members to be drawn toward the first support bar to thereby pin a portion of an article between the first support bar and the first and second coupling members.

2. The cart according to claim 1, further including a rear transverse frame member connecting the first and second lateral frame members, wherein the rear transverse member connects the first and second lateral frame members adjacent the rearward end of the base to thereby create the opening at the forward end of the base.

3. The cart according to claim 1, further including a leveling assembling.

4. The cart according to claim 3, wherein the leveling assembly includes a support arm secured to the first support bar and a leveling clamp secured to the support arm.

5. The cart according to claim 5, wherein the leveling clamp is positioned beneath the support arm for ready adjustment relative thereto through the use of an adjustment mechanism.

6. The cart according to claim 5, wherein the adjustment mechanism is a screw mechanism which draws the leveling clamp up and down relative to the support arm by rotation thereof.

7. The cart according to claim 3, wherein the leveling clamp is generally L-shaped with a vertical leg and a horizontal leg.

8. The cart according to claim 7, wherein a concave portion of the leveling clamp faces outwardly toward the forward end of the base.

9. The cart according to claim 7, wherein the semi-elliptical horizontal leg is semi-elliptical and is shaped and dimensioned to fit beneath a rim of a toilet bowl.

10. The cart according to claim 1, wherein the coupling members are L-shaped with a vertical leg and a horizontal leg.

11. The cart according to claim 10, wherein the semi-elliptical horizontal leg is semi-elliptical and is shaped and dimensioned to fit beneath a rim of a toilet bowl.

12. The cart according to claim 1, wherein the base further includes a pair of front wheels along the forward end.

13. The cart according to claim 12, wherein the rear wheels are mounted to the base for rotation about a fixed axis and the front wheels being mounted to the base for pivotal movement permitting maneuvering of the cart.

14. The cart according to claim 12, wherein the proximal ends of the first and second upwardly extending arm each include a handle that comprises a U-shaped member curved rearwardly from a first plane in which the first and second upwardly extending arms lie.

15. The cart according to claim 14, wherein a forward end of the U-shaped member is aligned with the first plane and a rearward end of the of the U-shaped member is aligned with a rearward edge of the pair of rear wheels, the rearward end and the rearward edge of the pair of rear wheels lie in a second plane substantially parallel to the first plane, the configuration permitting inversion of the cart to a resting position on the second plane wherein the second plane is parallel to the support surface and substantially parallel to the first plane.

16. The cart according to claim 1, wherein the first and second coupling members are secured to the first support bar for selective movement relative thereto in a manner permitting ready attachment to the article.

17. The cart according to claim 16, wherein the first support bar includes slots in which the first and second coupling members are mounted for movement along the first support bar.

18. The cart according to claim 1, wherein the crank arm includes a threaded shaft that engages a threaded cylinder secured to the first support bar.

19. The cart according to claim 18, wherein the threaded shaft is telescopically received within the threaded cylinder.

20. The cart according to claim 1, wherein the base includes first and second lateral frame members each including a forward arm and a rear support plate, wherein the rear support plates of the first and second lateral frame members are secured to the first and second upwardly extending arms respectively, each of the first and second lateral frame members includes a set screw, a storage groove, a use groove, wheels along a rearward end, and wheels along a forward end, wherein the set screw provides a pivot point permitting rotation of the forward arm into the storage groove or the use groove.
